(19) United States
(12) Patent Application Publication
(10) Pub. No.: US 2006/0181907 A1
(43) Pub. Date: Aug. 17, 2006

(54) Method and inverter for supplying alternating current to a network

(75) Inventors: Lorand Cesnak, Vienna (Wien) (AT); Gerald Eckl, Schleinbach (AT)

Correspondence Address: MONTE & MCGRAW, PC, 4092 SKIPPACK PIKE, P.O. BOX 650, SKIPPACK, PA, 19474, US

(73) Assignee: Siemens AG Osterreich, Vienna (Wien) (AT)

(21) Appl. No.: 11/352,541

(22) Filed: Feb. 13, 2006

(30) Foreign Application Priority Data
Jul. 26, 2004 (WO) PCT/AT04/00268
Aug. 13, 2003 (AT) A1275/2003

(51) Int. Cl. H02M 7/537

(52) U.S. Cl. 363/131

(57) ABSTRACT

A method for supplying alternating current to a network (NET), according to which a direct current is converted to an alternating current with a line frequency, with the aid of an inverter (WER) and the output of the inverter is connected to the network. The terminal voltage (u(t)) is measured and the output current (i(t)) of the inverter (WER) is regulated in such a way that it essentially corresponds to the quotient of the square sine current power P₀·sin²(ωt) and the terminal voltage (u(t)), thus i(t)=P₀·sin²(ωt)/u(t).

### CROSS-REFERENCE TO RELATED APPLICATIONS

This application claims priority from PCT Application Serial No. PCT/AT2004/000268 filed Jul. 26, 2004 which claims priority from Austrian Patent Application Serial No. A 1275/2003 filed Aug. 13, 2003.

### FIELD OF THE INVENTION

The present invention is in the field of electrical circuits and more particularly in current inverter circuits.

### BACKGROUND OF THE INVENTION

The invention relates to a method for supplying alternating current to a network, according to which a direct voltage is converted to an alternating voltage with a line frequency using an inverter and the output of the inverter is connected to the network. The invention also relates to an inverter for converting an input direct voltage of a direct voltage power source into an output alternating voltage with a line frequency whose output is connected to terminals of an alternating current network in order to supply energy from the direct voltage power source to the network.

In particular with so-called alternative energy sources, such as solar or fuel cells with relatively little output in the kilowatt range and below, high efficiency electronic inverters are used. Because of the low peak current output, such inverters exhibit a current source behavior, that is, they are controlled in such a manner that a sinusoidal current is fed into the network.

On the other hand, the direct current generators of the power plants, which are usually the main energy suppliers of a network, exhibit the behavior of voltage sources that supply a sinusoidal voltage with a line frequency to the network. A network together with its consumers exhibits—seen from the supply sources—no pure ohmic behavior, rather, capacitive and inductive components are present. Moreover—and this was the reason for the present invention—the network together with its consumers is not a linear impedance. The non-linearities cause distorted voltages and currents and accordingly harmonics of the line frequency. This means that generators, which supply the network, and also transformers must also supply currents with multiplex frequency, e.g., 150 Hz. This is possible, for example, in three-phase generators with their low internal resistance, but this causes additional losses in the generators and transformers, which are sized for the line frequency, e.g., 50 Hz. Therefore, it is desirable to keep these additional losses, which result at high frequencies from copper losses and from iron losses in the generators, as small as possible.

However, the additional energy supply from a large number of small inverters from solar plants or fuel cells exacerbates the aforementioned problem. As already mentioned, the inverters of such small or mini or subminiature suppliers supply a sinusoidal current with a line frequency in the network and therefore do not cover the demand of the network for portions of current having multiplex line frequency. However, as a result the actual power plants with their three-phase generators are again burdened in the range of the harmonics, which further lowers the efficiency of the generators.

One object of the present invention is to counteract the problems described above, i.e., to reduce the burden of the actual power plants with harmonics when small current suppliers having alternating voltage transformers are used.

### BRIEF SUMMARY OF THE INVENTION

This objective is achieved using a method of the type mentioned at the outset in which according to the invention the terminal voltage u(t) and the output current of the inverter is controlled in such a way that it corresponds to the quotient of sinusoidal square-shaped instantaneous power P₀·sin²(ωt) and terminal voltage u(t), thus: i(t)=P₀·sin²(ωt)/u(t).

Thanks to the invention, harmonic waves of the supply current are fed to the network so that the power stations are less burdened with harmonics. This objective is achieved in the same way using an inverter of the currently realized type in which according to the invention the output current i(t) at the terminals is controlled as a function of the measured terminal voltage u(t) in such a manner that it essentially corresponds to the quotient of sinusoidal square-shaped instantaneous power P₀·sin²(ωt) and terminal voltage u(t), thus: i(t)=P₀·sin²(ωt)/u(t).

Such an inverter is suited in a particular way for supplying the network from alternative energy sources, such as solar or fuel cells.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 diagrammatically shows an equivalent circuit diagram of a network, its consumers and two power suppliers; and

FIG. 2 shows a possibility of realization of the method of the invention using a possible trigger circuit of an inverter.

### DETAILED DESCRIPTION OF THE INVENTION

In the drawings, like numerals indicate like elements throughout. In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

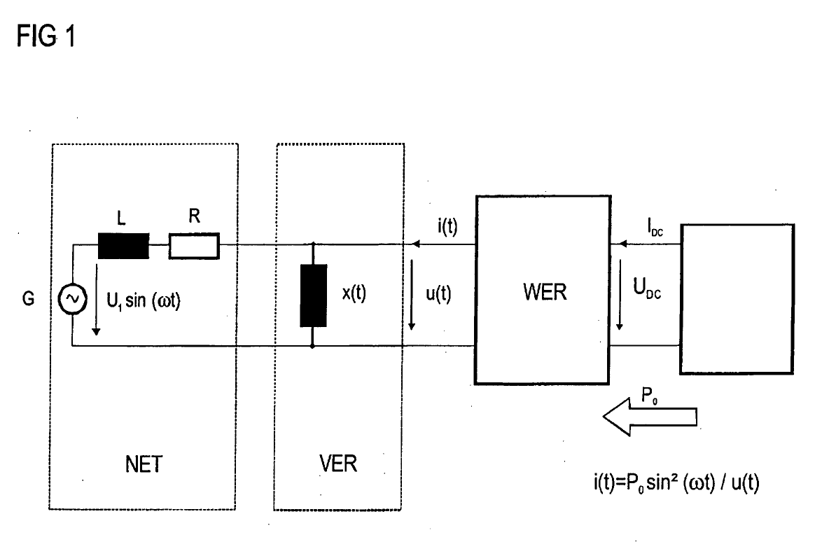

According to FIG. 1, consumers are to be supplied with electrical energy, these consumers together representing a non-linear impedance X(t), in which the connection between voltage and current, such as in semi-conductor band elements, is not linear. The consumers are supplied with power by a supply network NET, which in this case is comprised of an alternating voltage source G in series with an inductor L and an ohmic resistor R. The alternating voltage source G can as usual be a three-phase generator or generator block of a caloric or hydroelectric power station. A typical value for line resistor R could be within the range of a tenth of an ohm, one for line inductor L within the range of one mH. Not depicted, because they are of less significance, are line capacitors.

The consumers VER are also supplied by alternative energy sources or miniature or subminiature power stations that supply energy in the watt or kilowatt range to network NET. These may be voltaic solar plants or fuel cells whose direct current UDC is fed into the network via an inverter WER to consumers VER.

The invention then provides a special type of infeed via the inverters, which also in this case in a known way supply a line-frequency alternating voltage u(t) and an accompanying alternating current i(t). More precisely, output current i(t) of inverter WER is controlled in such a manner that it essentially corresponds to the quotient of instantaneous power P₀·sin²(ωt) and terminal voltage u(t). Therefore, the following equation applies: i(t)=P₀·sin²(ωt)/u(t).

If output current i(t) of the inverter is controlled in this manner, current suppliers of this type can also feed harmonic waves to the network or the consumers, which causes less of a burden with undesired harmonics to the three-phase generators. It should also be noted that standard inverters feed a de facto constant current into the network from the miniature/subminiature power suppliers in question.

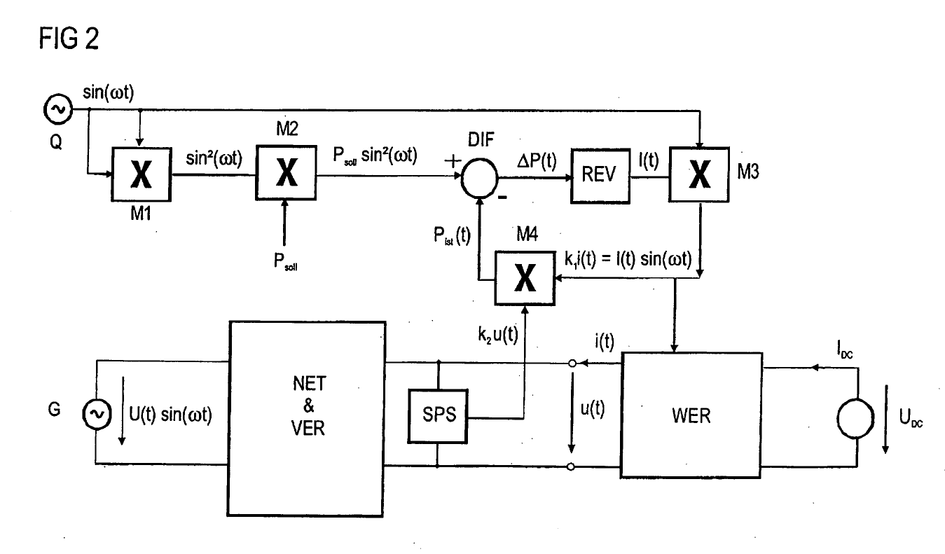

Starting from the current control provided according to the invention, many realization possibilities are available to one skilled in the art. An exemplary embodiment is explained for this purpose in reference to FIG. 2.

As FIG. 2 shows, an inverter WER is assumed in which the output current can be divided, which is possible without a problem for electrical inverters of known design. Terminal voltage u(t) of inverter WER is detected using a voltage sensor SPS, which supplies a signal k₂·u(t).

In the trigger circuit, starting signal sin(ωt) of an alternating voltage source Q is multiplied using a multiplier M1, which supplies a signal of the form sin²(ωt). This signal is multiplied in a second multiplier M2 with a reference power value Pₛₒₗₗ and the received signal arrives at the input of a summing or subtracting rectifier DIF, whose output signal ΔP(t) is supplied to a control amplifier REV.

The output I(t) of control amplifier REV arrives at an input of a third multiplier M3 to whose other input the output signal of alternating voltage source Q is supplied. Signal I(t) sin(ωt)=k₁·i(t) is supplied as the output signal of multiplier M3 to the current input of inverter WER. Moreover, this signal and the previously mentioned voltage signal k₂·u(t) arrives at the two inputs of a fourth multiplier M4, which detects actual power Pᵢₛₜ(t) and supplies it to an input of the summing or subtracting rectifier DIF.

The example described above, then, describes one realization possibility. Actually, many other solutions are possible. In particular, the control can also be implemented in a digital manner using a microprocessor.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

1. A method for supplying alternating current to a network, according to which a direct voltage is converted to an alternating voltage with a line frequency using an inverter and the output of the inverter is connected to the network,
wherein
the terminal voltage (u(t)) is measured and the output current (i(t)) of the inverter is controlled in such a manner that it essentially corresponds to the quotient of sinusoidal square-shaped instantaneous power P₀·sin²(ωt) and the terminal voltage (u(t)), thus: i(t)=P₀·sin²(ωt)/u(t).

2. An inverter for converting an input direct voltage of a direct voltage power source into an output alternating voltage with a line frequency whose output is connected to terminals of an alternating current network in order to supply energy from the direct voltage source into the network,
wherein
the output current (i(t)) at the terminals is controlled as a function of the measured terminal voltage (u(t)) in such a manner that it essentially corresponds to the quotient of sinusoidal square-shaped instantaneous power P₀·sin²(ωt) and the terminal voltage (u(t)), thus:
i(t)=P₀·sin²(ωt)/u(t).

3. The inverter as described in claim 2 for supplying a network from alternative energy sources, such as solar or fuel cells.
